(19) United States
(12) Patent Application Publication
(10) Pub. No.: US 2008/0002577 A1
(43) Pub. Date: Jan. 3, 2008

(54) Efficient allocation of shapers

(75) Inventors: Swapna Bapat, Westford, MA (US); Xin Zhou, Shrewsbury, MA (US)

Correspondence Address: WERNER & AXENFELD, LLP, P.O. BOX 1629, WEST CHESTER, PA, 19380, US

(73) Assignee: Lucent Technologies, Inc.

(21) Appl. No.: 11/478,233

(22) Filed: Jun. 29, 2006

(51) Int. Cl. H04L 12/26; H04L 12/56; H04J 3/22

(52) U.S. Cl. 370/230; 370/468; 370/395.2

(57) ABSTRACT

Apparatus and method of efficiently allocating circuits to shapers is described. Shapers are designated as part of a first set or a second set of shapers. Each shaper of the first set has at least one circuit allocated for shaping, whereas shapers comprising the second set of shapers have no circuits allocated for shaping. When a new circuit comprising packets having an urgency of service is received, a determination is made whether any shaper from the first set of shapers has adequate bandwidth and granularity to shape with the new circuit. If not, the circuit is assigned to a shaper from the second set of shapers, and the shaper is then designated as part of the first set of shapers. Correspondingly, if a shaper from the first set of shapers has completed shaping any circuits assigned to it, then the shaper is designated as part of the second set of shapers.

### TECHNICAL FIELD

The present invention relates generally to communications and computer network traffic, and more specifically, to traffic shaping on a computer network.

### BACKGROUND

Networks are a principle way of exchanging or transferring information, for example, signals representing voice, audio, text and/or video among communication devices. The exchange or transfer of information is referred to as a call or connection. Information transmitted on the network can be of many different forms including fixed-length packets or cells.

A network typically includes switches having ports coupled by links to ports of other switches or communications devices. Each link is uni- or bi-directional and is characterized by a bandwidth or link capacity. Information to be exchanged is often conveyed over a path comprising a set of nodes and links connecting the communication devices. The path can be regarded as a virtual circuit (VC) whereby one communication device specifies the intended destination for the information, and the network delivers the information as though a dedicated circuit connected the two communication devices. Cells in transit between communication devices may temporarily be stored in buffers at nodes along the path of the virtual circuit pending sufficient available bandwidth on subsequent links along the path.

Networks employing asynchronous transfer mode (ATM) packet switching are not only still being used for the reliable, high-speed transmission of information but their use is increasing in popularity. This increased network use has brought major changes in network architecture and infrastructure design as well as in network operations and/or in the classes of services offered over the network. Classes of services offered over a network can include, for example, video-on-demand and video teleconferencing. Moreover, particular classes of services, such as video teleconferencing, are relatively sensitive to routing delays and receive higher priorities than other service classes, such as non-real-time data, which are relatively delay insensitive.

A major issue today with service providers is to ensure that real-time data (such as a telephone call) is routed with quality of service so as to ensure customer reliability. All such real-time data is typically assigned to a traffic shaper in a router at network edges between the service provider's customers and the customer. A traffic shaper is a device (logic and/or circuit) in the switch which ensures that bursty and variable data, is regulated according to the quality of service it prescribed by the urgency of service of the packet, such as data cells.

In general, a shaper converts an arbitrary traffic flow of packets into a smoothed traffic flow at a specified data rate. That is, a shaper is a circuit and/or logic used in a switch to ensure that traffic is transmitted at specified intervals. Currently, methods of shaping involve shaping of traffic at the aggregate rate of the shaper, which results in a loss in quality for the data on that circuit.

In a typical network environment hundreds of thousands of real-time data packets enter the network requiring shaping, including time-sensitive traffic, such as video and voice. Shaping of such a high number of circuits can place too great of a demand on network resources and on the processor. Even employing current shaping techniques, frequent problems arise when a high volume of time-sensitive traffic enters the network. Frequently, packets containing video and voice are dropped, and latency increases resulting in queued packets that are delayed for transmission. Dropped calls and delayed transmission result in an overall poor quality of transmission of real-time data packets and other time-sensitive traffic.

Currently, no method of shaping traffic adequately addresses these problems to permit efficient shaping of time-sensitive traffic so that video and voice packets are not delayed in transmission or dropped from the network.

### SUMMARY

Described herein is an apparatus and method for efficiently allocating circuits to shapers which results in reduced packet loss and increased quality of data being sent over a network. In one method implementation, shapers are designated as part of a first set or a second set of shapers. Each shaper of the first set of shapers has at least one circuit allocated for shaping, whereas shapers comprising the second set of shapers have no circuits allocated for shaping. When a new circuit comprising packets having an urgency of service is received, a determination is made whether any shaper from the first set of shapers has adequate bandwidth and granularity to shape with the new circuit. Granularity represents the minimum possible bandwidth that may be allocated to a circuit. If bandwidth and granularity requirements are not met, the circuit is assigned to a shaper from the second set of shapers, and the shaper containing the newly-allocated circuit is then re-designated as part of the first set of shapers. Correspondingly, if a shaper from the first set of shapers has completed shaping any circuits assigned to it and becomes free of any circuits allocated to it, then the shaper is designated as part of the second set of shapers.

Thus, the invention efficiently allocates packets having an urgency of service to shapers having optimal granularity and bandwidth with which to shaper the packets, by first attempting to utilize all shapers currently allocated to shaping other circuits, before allocating the packets to shapers not in use. This forces the node to exhaust all available shaper bandwidth and granularity, rather than randomly assigning circuits to shapers as they are received.

### BRIEF DESCRIPTION OF THE DRAWINGS

The detailed description is explained with reference to the accompanying figures. In the figures, the left-most digit(s) of a reference number identifies the figure in which the reference number first appears.

FIG. 1 illustrates a node facilitating allocation of circuits to shapers.

FIG. 2 illustrates an overview of efficient shaper allocation.

FIG. 3 shows a flow chart of an exemplary method of efficient shaper allocation.

FIG. 4 illustrates an overview of a processor housing computer-executable instructions for allocation of shapers.

### DETAILED DESCRIPTION

### Exemplary Methods of Operation

### Described herein are techniques for efficiently allocating circuits to shapers in a node of an ATM network.

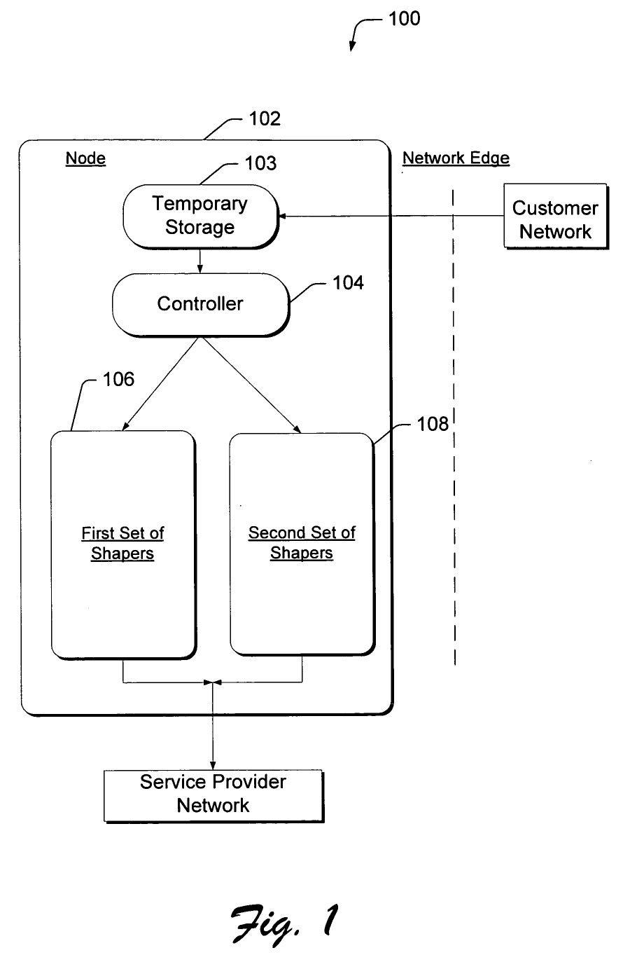

FIG. 1 illustrates a node to allocate circuits to shapers in accordance with the invention.

Referring to FIG. 1, node 102 comprises a temporary storage unit 103, a controller 104, and shapers logically assigned to one of two sets; a first set of shapers 106 and a second set of shapers 108. Node 102 resides at the edge of an ATM network and is capable of receiving incoming circuits from a customer network and routing shaped circuits across a service provider network.

Node 102 includes any computing device capable of shaping and routing circuits such as a router, a switch, a server, or other network device. In one implementation, node 102 is an asynchronous transfer mode (ATM) edge router to shape circuit(s) having an urgency of service as they enter the network.

In one implementation, the incoming circuit comprises packets, wherein the packets are cells configured in accordance with an ATM protocol. In yet another implementation, the incoming circuit has an urgency of service requiring a constant bit rate (CBR) or a variable bit rate (VBR) quality of service.

In one implementation, temporary storage 103 is a buffer configured to receive a new circuit comprising packets having an urgency of service.

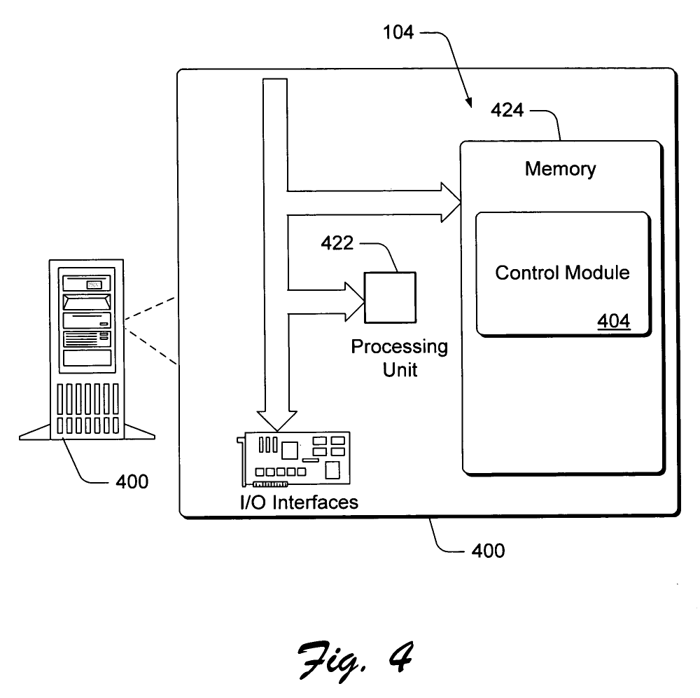

In one implementation, controller 104 is a processing unit shown in more detail at FIG. 4.

First set of shapers 106 and second set of shapers 108 differ in the presence or absence of allocated circuits within the set. The second set of shapers 108 differs from the first set of shapers 106 in that the second set of shapers 108 are void of any circuits. A shaper, whether designated as part of first or second set, is a device (logic and/or circuit) in the switch which ensures that bursty and variable data is regulated according to the quality of service prescribed by the urgency of service of the packet.

Shaper allocation begins when a circuit containing time-sensitive traffic having an urgency of service, such as video or voice data, enters a network and is received by a node apparatus 102 located at the edge of the network. Temporary storage 103 captures incoming circuits. Controller 104 logically allocates the incoming circuit amongst two pools of shapers; the first set of shapers 106 or the second set of shapers 108. The second set of shapers 108 differs from the first set of shapers 106 in that the second set of shapers 108 are void of any pre-allocated circuits. Incoming circuits that are logically assigned to an appropriate shaper based on bandwidth and granularity are then routed from the node 102 as shaped packets.

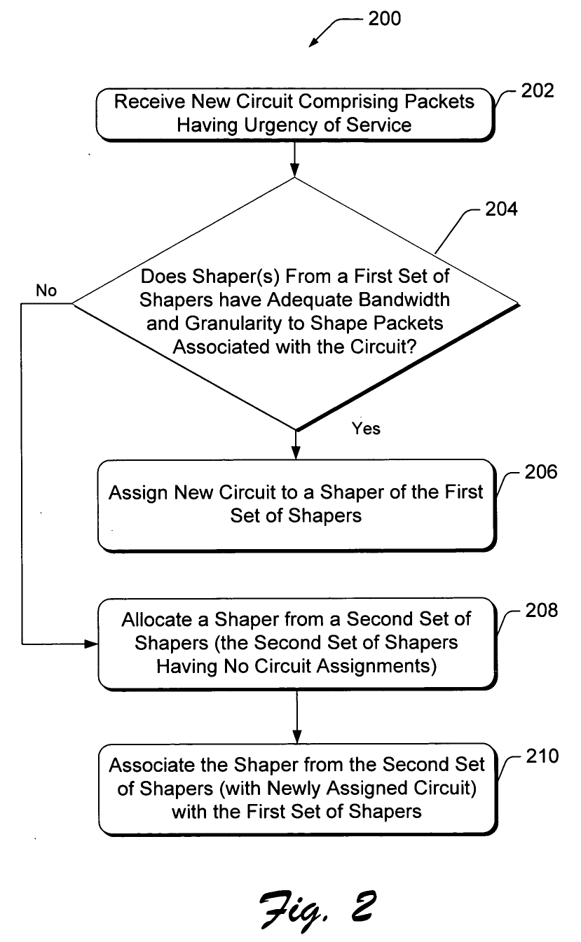

FIG. 2 illustrates an overview of an exemplary novel method 200 for efficient shaper allocation. Method 200 includes blocks 202, 204, 206, 208 and 210, with each block representing one or more operational acts. The order in which the method is described is not to be construed as a limitation, and any number of the described method blocks can be combined in any order to implement the method. Furthermore, the method can be implemented in any suitable hardware, software, firmware or combination thereof.

Shaper allocation begins when a circuit comprising packets having an urgency of service enters the network. In one implementation, the packets are cells configured in accordance with asynchronous transfer mode protocol. In another implementation, the urgency of service is one requiring a constant bit rate (CBR) or variable bit rate (VBR) quality of service.

The incoming circuit is allocated to one of a plurality of shapers in a data transmission system based upon bandwidth and granularity; circuits are assigned to shapers meeting a bandwidth requirement and not exceeding a granularity requirement. Based on bandwidth of the incoming circuit, the circuit is allocated to a shaper from one of two pools.

Shapers having at least one allocated circuit in the shaper are designated as part of the first set of shapers 106. Shapers void and free of any allocated circuits are designated as part of the second set of shapers 108. As incoming having an urgency of service enters the network, computer executable instructions executing on at least one processor determine if at least one shaper from the first set of shapers 106 has adequate bandwidth and granularity to shape packets associated with the new circuit (shown at block 204). If adequate bandwidth and granularity exist in the shaper from first set of shapers 106 then the circuit is assigned to the shaper from the first set of shapers 106 (shown at block 206). If no shaper from first set of shapers 106 has adequate bandwidth and granularity to shape the incoming circuit, then circuit is allocated to a shaper from the second set of shapers 108 (shown at block 208).

Block 210 shows that once a shaper from the second set of shapers 108 has been allocated to shaper an incoming circuit, the shaper from the second set of shapers will become associated with the shapers of the first set of shapers 106.

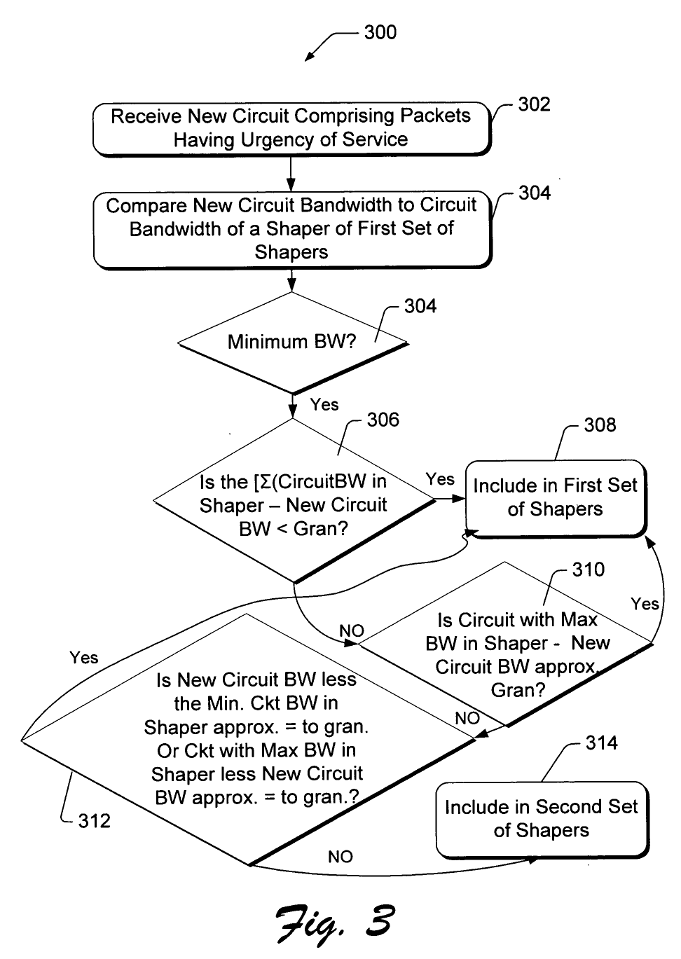

FIG. 3 shows a flow chart of an exemplary novel method of efficient shaper allocation. Method 300 includes blocks 302, 304, 306, 308, 310, 312 and 314, with each of the blocks representing operational acts. The order in which the method is described is not to be construed as a limitation, and any number of the described method blocks can be combined in any order to implement the method. Furthermore, the method can be implemented in any suitable hardware, software, firmware, or combination thereof.

The novel method 300 of shaper allocation begins at block 302 when a new circuit comprising packets having an urgency of service and in need of shaping is received as it enters the network.

The bandwidth of the incoming circuit is checked against a bandwidth of shaper of a first set of shapers 106. If the minimum bandwidth in the shaper of a first set of shapers 106 is compatible with the bandwidth of the incoming circuit, circuit bandwidth is compared to granularity.

Block 306 shows a comparison of bandwidth to granularity. Granularity is the minimum possible bandwidth that can be allocated to a circuit. The sum of the difference between bandwidth of the circuits in the shaper of the first set of shapers 106 and the bandwidth of the incoming circuit must be less than or equal to granularity. If this condition is met, the incoming circuit is included in the shaper of the first set of shapers 106, shown at block 308.

If the condition at block 306 is not met, a less stringent comparison of circuit bandwidth to granularity is performed at block 310. When the condition at block 306 is not met a second comparison is carried out to determine if the difference between the bandwidth of incoming circuit and a maximum bandwidth of a circuit of the shaper of the first set of shapers 106. Block 310 determines if the difference between the maximum bandwidth of the circuit of the first set of shapers 106 and bandwidth of incoming circuit is approximately equal to granularity. If this condition is met, the incoming circuit is included in the first set of shapers shown at block 308.

When the condition at block 310 is not met a third and less stringent comparison is carried out to determine if the difference between either the bandwidth of incoming circuit and a maximum bandwidth of a circuit of the shaper of the first set of shapers 106 or the difference between the bandwidth of incoming circuit and a minimum bandwidth of a circuit of the shaper of the first set of shapers 106, is equal or approximately equal to the granularity of shaper of a first set of shapers 106. (Shown at block 312) If either condition is met, the incoming circuit in included in the first set of shapers 106 (Shown at block 308).

If the conditions at block 312 are not met, block 314 shows allocating a shaper from a second set of shapers 108 to shaper traffic associated with the incoming circuit if no shaper from the first set of shapers 106 has adequate bandwidth and granularity to shaper the new circuit. (See block 314)

In one implementation, when a shaper from the second set of shapers 108 is allocated a new circuit, the shaper from the second set of shapers 108 becomes associated with the first west of shapers 106.

In another implementation, the steps shown at blocks 302, 304, 306, 308, 310, 312, 314, may be iteratively repeating steps for each new incoming circuit received by the data transmission system, until all shapers with adequate bandwidth and granularity from the first and second set of shapers are fully consumed.

FIG. 4 illustrates an exemplary physical representation of controller 104 and a computer platform 400 used to implement functionality performed by node 102. (See FIG. 1) In particular, computer platform 400 represents any general purpose or special purpose computing system with modifications to hardware, firmware, and/or software. Computer platform 400 is only one example of computer platform and is not intended to suggest any limitation as to the scope of use or functionality of any method or apparatus described herein.

Computer platform 400 includes a control module 404, which controls operation of platform 400. Control module 404 can be implemented in hardware, firmware, logic, software or any combination thereof. In the illustrative exemplary implementation control module 404 is implemented as a computer program module that may be described in the general context of computer-executable instructions, being executed by a computer, i.e., one or more processors in a processing unit 422. Control module 404 resides in memory 424.

Memory 424 typically includes a variety of computer readable media. Such media can be any available media that is accessible by computer platform 400 and includes both volatile and non-volatile media, removable and non-removable media. The computer-readable media provide non-volatile storage of computer readable instructions, data structures, program modules and other data for computer platform 400. Any number of program modules can be stored in the computer readable media of memory 424, including one or more portions of control module 404.

It is also noted that portions of control module 504 may be stored in a remote memory storage device remote from computer platform 400. Additionally, even though control module 404 is illustrated herein as a discrete block, it is recognized that any of these components may reside at various times in different storage components of computer platform 400 and are executed by one or more processors of a computer, such as processing unit 422.

The embodiments described herein are to be considered in all respects only as exemplary and not restrictive. The scope of the invention is, therefore, indicated by the subjoined Claims rather by the foregoing description. All changes which come within the meaning and range of equivalency of the Claims are to be embraced within their scope.

What is claimed is:

1. A method of allocating circuits to one of a plurality of shapers in a data transmission system, comprising:
(A) receiving a new circuit comprising packets having an urgency of service;
(B) determining whether at least one shaper from a first set of shapers has adequate bandwidth and granularity to shape packets associated with the new circuit, wherein each shaper of the first set of shapers has at least one circuit allocated to it when the new circuit is received;
(C) assigning the new circuit to at least one shaper of the first set of shapers based on a determination that the at least one shaper has adequate bandwidth and granularity to shape packets associated with the new circuit; and
(D) allocating a shaper from a second set of shapers to shape traffic associated with the new circuit if no shaper from the first set shapers has adequate bandwidth and granularity to shape the new circuit.

2. The method of claim 1, further comprising iteratively repeating the acts specified in paragraphs A through D for each new circuit received by the data transmission system, until all shapers with adequate bandwidth and granularity from the first and second set of shapers are fully consumed.

3. The method of claim 1, wherein granularity is a minimum possible bandwidth that can be assigned to a new circuit.

4. The method of claim 1, associating a shaper from the second set of shapers with first set of shapers after the shaper from the second set of shapers is allocated to the new circuit.

5. The method of claim 1, wherein the packets are cells configured in accordance with an asynchronous transfer mode (ATM) protocol.

6. The method of claim 1, wherein the urgency of service requiring at least one of a Constant Bit Rate (CBR) and Variable Bit Rate (VBR) Quality of Service.

7. The method of claim 1, wherein shaping provides better than the standard IP diffserv class based quality of service (QoS)

8. A method of allocating circuits to one of a plurality of shapers in a data transmission system, comprising:
designating each shaper having at least one circuit allocated to it as part of a first set of shapers;
designating each shaper free of any circuits allocated to it as part of a second set of shapers;
receiving a new circuit comprising packets having an urgency of service;
determining whether at least one shaper from the first set of shapers has adequate bandwidth and granularity to shape packets associated with the new circuit; and
assigning the new circuit to at least one shaper of the first set of shapers based on a determination that the at least one shaper has adequate bandwidth and granularity to shape packets associated with the new circuit.

9. The method of claim 8, further comprising allocating a shaper from a second set of shapers to shape traffic associated with the new circuit if no shaper from the first set of shapers has adequate bandwidth and granularity to shape the new circuit.

10. The method of claim 9, further comprising designating the shaper from the second set of shapers with the first set of shapers upon allocation of the shaper to the new circuit.

11. The method of claim 8, wherein granularity is a minimum possible bandwidth that can be assigned to a new circuit.

12. The method of claim 8, associating a shaper from the second set of shapers with first set of shapers after the shaper from the second set of shapers is allocated to the new circuit.

13. The method of claim 8, wherein the packets are cells configured in accordance with an asynchronous transfer mode (ATM) protocol.

14. The method of claim 8, wherein the urgency of service requiring at least one of a Constant Bit Rate (CBR) and Variable Bit Rate (VBR) Quality of Service.

15. An apparatus, comprising:
a plurality of shapers;
a controller configured to allocate circuits received by a switch to the plurality of shapers; the controller configured to designate each shaper having at least one circuit allocated to it as part of a first set of shapers and to designate each shaper free of any circuits allocated to it as part of a second set of shapers;
a buffer configured to receive a new circuit comprising packets having an urgency of service;
means for determining whether at least one shaper from the first set of shapers has adequate bandwidth and granularity to shape packets associated with the new circuit; and
means for assigning the new circuit to at least one shaper of the first set of shapers based on a determination that the at least one shaper has adequate bandwidth and granularity to shape packets associated with the new circuit.

16. The apparatus of claim 15, further comprising means for allocating a shaper from a second set of shapers to shape traffic associated with the new circuit if no shaper from the first set of shapers has adequate bandwidth and granularity to shape the new circuit.

17. The apparatus of claim 16, further comprising means for designating the shaper from the second set of shapers with the first set of shapers upon allocation of the shaper to the new circuit.

18. The apparatus of claim 15, wherein the means for determining and the means for assigning comprises computer-executable instructions executing on at least one processor.

19. The apparatus of claim 15, wherein the apparatus is an ATM edge node.

20. The apparatus of claim 15, wherein the urgency of service requires at least one of a Constant Bit Rate (CBR) and Variable Bit Rate (VBR) Quality of Service.
